(19) United States
(12) Patent Application Publication
(10) Pub. No.: US 2026/0204816 A1
(43) Pub. Date: Jul. 16, 2026

(54) CONNECTOR MODULE AND ELECTRONIC DEVICE

(71) Applicant: DONGGUAN LEADER PRECISION INDUSTRY CO., LTD., Dongguan City (CN)

(72) Inventors: Bo WANG, Dongguan City (CN); Jinqi LI, Dongguan City (CN); Zhengguo SUN, Dongguan City (CN); Jiamei WAN, Dongguan City (CN)

(73) Assignee: DONGGUAN LEADER PRECISION INDUSTRY CO., LTD., Dongguan City (CN)

(21) Appl. No.: 19/384,351

(22) Filed: Nov. 10, 2025

(30) Foreign Application Priority Data
Nov. 11, 2024 (CN) 202411604181.9

(51) Int. Cl. H01R 12/70

(52) U.S. Cl. CPC H01R 12/7047; H01R 2201/04

(57) ABSTRACT

Disclosed are a connector module and an electronic device. The connector module includes: a connector body including a first conductive terminal and a connecting ear that extends outward along a first direction of the connector body, in which the first conductive terminal and the connecting ear are disposed at intervals in a second direction of the connector body; a main board provided with a first avoidance notch passing through the main board along a third direction of the connector body and a n electrical contact site disposed corresponding to the first conductive terminal, in which at least part of the connector body is plugged in the first avoidance notch, and the first conductive terminal abuts against and is electrically connected with the electrical contact site; and a locking assembly locking the connector body and the main board through the connecting ear in the third direction.

### CROSS-REFERENCE TO RELATED APPLICATION(S)

The present disclosure claims priority of Chinese Patent Application No. 202411604181.9 filed Nov. 11, 2024 and entitled “Connector Module and Electronic Device”, which is incorporated herein by reference in its entirety.

### FIELD

The present disclosure relates to the technical field of electronic devices, particularly to a connector module and an electronic device.

### BACKGROUND

A connector generally refers to an electrical connector, that is, an intermediate device connecting two active devices and configured to transmit a current or a signal. At present, the bottom of the connector is generally connected directly to a top position of a main board by welding or press-fitting, forming a one-piece member. The one-piece member has strong connection firmness, and cannot be disassembled at will subsequently. When a part on the main board is damaged, the main board needs to be replaced together with the connector, and the usage costs are high; moreover, the one-piece member has a large overall thickness, occupies much space, and is not suitable for an electronic device with small thickness assembly space.

### SUMMARY

An embodiment of the disclosure provides a connector module including: a connector body including a first conductive terminal and a connecting ear, wherein the connecting ear extends outward along a first direction of the connector body, and the first conductive terminal and the connecting ear are disposed at intervals in a second direction of the connector body; a main board provided with a first avoidance notch and an electrical contact site, wherein the first avoidance notch passes through the main board along a third direction of the connector body, the electrical contact site is disposed corresponding to the first conductive terminal, at least part of the connector body is plugged in the first avoidance notch, and the first conductive terminal abuts against and is electrically connected with the electrical contact site; and a locking assembly locking the connector body and the main board through the connecting ear in the third direction.

An embodiment of the disclosure further provides an electronic device including the connector module.

### BRIEF DESCRIPTION OF THE DRAWINGS

FIG. 1 is an exploded view of a connector module according to an embodiment of the present disclosure;

FIG. 2 is an assembly view of the connector module according to an embodiment of the present disclosure;

FIG. 3 is a cross-sectional view of FIG. 2 along a second direction;

FIG. 4 is a partial enlarged view of FIG. 3;

FIG. 5 is an exploded view of FIG. 4;

FIG. 6 is a partial enlarged view of a connector main body of the connector module according to the embodiment; and

FIG. 7 is a partial enlarged view of a connector module according to another embodiment of the present disclosure.

### DETAILED DESCRIPTION

In order to make objects, technical solutions, and advantages of embodiments of the disclosure clearer, the technical solutions in the embodiments of the disclosure will be clearly and fully described in combination with the accompanying drawings in the embodiments of the present disclosure. Obviously, the embodiments to be described are part of embodiments but not all embodiments of the disclosure. Based on the embodiments of the disclosure, all other embodiments obtained by those of ordinary skill in the art without inventive work shall fall within the scope of the disclosure.

Many different embodiments or examples are disclosed below to realize different structures of the disclosure. In order to simplify the disclosure, components and arrangements of specific examples are described below. Of course, they are only exemplary and are not intended to limit the disclosure. Furthermore, the present disclosure may repeat reference numerals and/or letters in different examples. The repetition is for simplicity and clarity, and in itself does not indicate the relationship between the various examples and/or arrangements discussed. Furthermore, examples of various particular processes and materials are provided herein, but one of ordinary skill in the art may recognize applicability of other processes and/or use of other materials.

For the convenience of description, spatial relationship terms can be used herein to describe the relative positional relationship or movement of one element or feature relative to another element or feature as shown in the drawings, such as “inside”, “outside”, “inner”, “outer”, “under”, “below”, “on”, “above”, “front” and “back”. This spatial relationship term is intended to include different orientations of the device in use or operation other than orientations depicted in the drawings. For example, if the device in the drawings has a position turnover, a posture change or a movement state change, these directional indications will change accordingly. For example, elements described as “under or below other elements or features” will be subsequently oriented as “on or over other elements or features”. Thus, the exemplary term “below” may include both orientations of above and below. The device may be otherwise oriented (rotated by 90 degrees or in other directions), and the spatial relationship description used herein are interpreted accordingly.

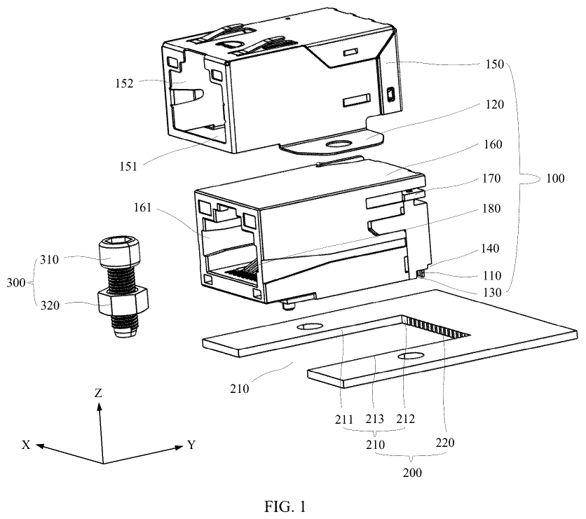

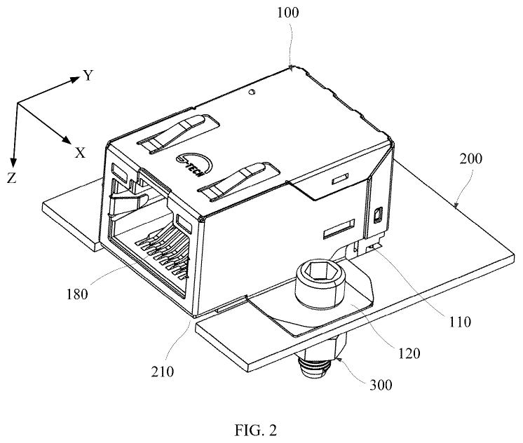

Referring to FIG. 1 and FIG. 2, an embodiment of the present disclosure provides a connector module including: a connector body 100 including a first conductive terminal 110 and a connecting ear 120, in which the connecting ear 120 extends outward along a first direction X of the connector body 100, and the first conductive terminal 110 and the connecting ear 120 are disposed at intervals in a second direction Y of the connector body 100; a main board 200 provided with a first avoidance notch 210 and an electrical contact site 220, in which the first avoidance notch 210 passes through the main board 200 along a third direction Z of the connector body 100, the electrical contact site 220 is disposed corresponding to the first conductive terminal 110, at least part of the connector body 100 is plugged in the first avoidance notch 210, and the first conductive terminal 110 abuts against and is electrically connected with the electrical contact site 220; and a locking assembly 300 locking the connector body 100 and the main board 200 in the third direction Z through the connecting ear 120.

In the embodiment, the first avoidance notch 210 is opened on the main board 200, and at least part of the connector main body is plugged in the first avoidance notch 210, so that the part of the connector main body plugged into the first avoidance notch 210 shares one thickness space with the main board 200, which effectively reduces an overall thickness of the connector module, so that the connector module may be adapted to a usage scenario with small thickness assembly space; at the same time, the connector body 100 is detachably connected with the main board 200 through the locking assembly 300, and when one thereof is damaged, only the damaged one may be replaced, and the other may continue to be used, which may greatly reduce usage costs. Compared with a welding/crimping connector in the related art, the connector module provided in the embodiment is detachable and flexible in assembly, having low usage costs; and an overall occupied space thereof is small, which is conducive to a thin and light layout of the connector module and the electronic device.

Specifically, the connector module is configured as a combined component at least including the connector body 100, the main board 200, and the locking assembly 300, the connector body 100 may be a near-rectangular box-shaped structure with wings, one end of the connector body 100 is opened for plugging an external active device, such as a plug connected to a power source; the other end is provided with the first conductive terminal 110 at least partially extending, and the extending part of the first conductive terminal 110 is configured for electrical connection with the main board 200. Thus, by installing the main board 200 on another external active device such as a computer or a mobile phone, the connector module conducts current between the two active devices; the connecting ear 120 provided on the connector body 100 may expand a connection position of the connector body 100 and the main board 200 outward, reduce interference with a main body part of the connector body 100, and facilitate subsequent disassembly and assembly. The main board 200 may be a plate-shaped structure with a circuit internally etched, the first avoidance notch 210 opened thereon may be in a shape such as rectangle, rhombus, triangle, or circle, which is not limited herein, and fits a shape of an inserted part of the connector body 100, and an operator can select one thereof according to an actual situation; the electrical contact site 220 provided thereon may be an exposed metal sheet-shaped structure, and is electrically connected with the circuit internally etched. Thus, conduction between the first conductive terminal 110 and an internal circuit of the main board 200 may be realized through the exposed electrical contact site 220, to realize the electrical connection between the connector body 100 and the main board 200. The locking assembly 300 may be a structural part such as a screw/bolt for realizing detachable connection between the connector body 100 and the main board 200. For example, the connecting ear 120 is provided with a through hole passing therethrough along the third direction Z, and the main board 200 is provided with a connecting hole corresponding to the through hole, the locking assembly 300 passes through the through hole and the connecting hole in sequence to connect and fasten the connector body 100 and the main board 200. When the main board 200 needs to be replaced subsequently, the locking assembly 300 may be loosened reversely, and the locking assembly 300 may be taken out from the through hole and the connecting hole, which is convenient for disassembly and assembly. The connector module provided in the example has a small occupied space, which can realize a thin and light layout, and the connector body 100 and the main board 200 are detachable, which is convenient for subsequent inspection and replacement of an easily damaged part, and reduces the usage cost.

In an example, the connector body 100 may be configured as a composite structure including at least a main body part, the first conductive terminal 110, and the connecting ear 120, the main body part has a near-rectangular box-shaped structure, two connecting ears 120 may be provided and are respectively disposed on two opposite sides of the main body part along the first direction X; the two connecting ears 120 extend away from each other, and respectively fit two locking assemblies 300 to connect and fasten the connector body 100 with the main board 200 in at least two areas in the first direction X; a tail end of the first conductive terminal 110 extends downward from the main body part to abut against the electrical contact site 220 on the main board 200 when the connector body 100 is plugged in the first avoidance notch 210, to realize conduction between the connector body 100 and the main board 200, which is convenient for transmitting a current or signal.

It needs to be explained that a straight line where the first direction X is, a straight line where the second direction Y is, and a straight line where the third direction Z is are perpendicular to each other. For example, the first direction X may be a width direction of the connector body 100, the second direction Y may be a length direction of the connector body 100, and the third direction Z may be a thickness direction of the connector body 100.

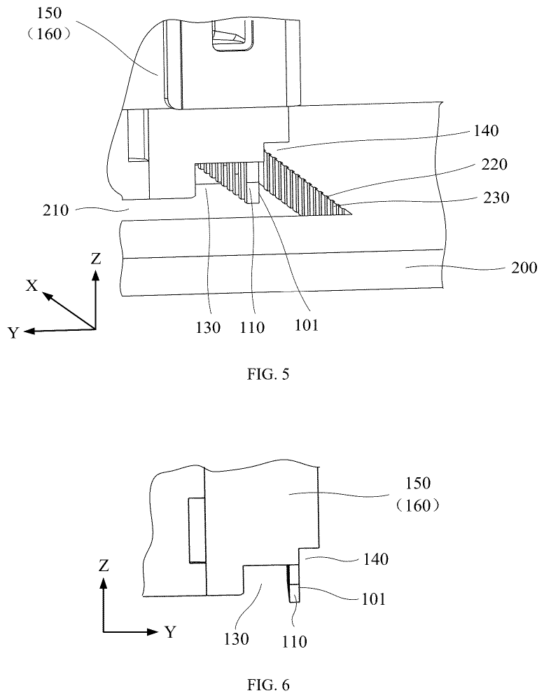

As shown in FIG. 1, FIG. 4, FIG. 5 and FIG. 6, in a possible example, the first avoidance notch 210 includes a first side wall 211, a second side wall 212, and a third side wall 213 that are disposed in sequence, the third side wall 213 and the first side wall 211 are disposed opposite and distributed at intervals in the first direction X, the electrical contact site 220 is disposed on the second side wall 212, the first conductive terminal 110 has a first abutment surface 101 exposed from the connector body 100 and facing the second side wall 212, and the first abutment surface 101 abuts against and is electrically connected with the electrical contact site 220 in the second direction Y.

This embodiment provides a manner of electrical connection between the first conductive terminal 110 and the electrical contact site 220 in the second direction Y, and at this time, the first conductive terminal 110 may be a long strip sheet-shaped structure. The first side wall 211, the second side wall 212, and the third side wall 213 enclose a U-shape, constituting an outermost shape of the first avoidance notch 210, a bottom of the connector body 100 may be plugged in the first avoidance notch 210 from above the main board 200, and at least two side walls of the connector body 100 respectively abut against the first side wall 211 and the third side wall 213, and the first abutment surface 101 on an outer side of the first conductive terminal 110 disposed on another side wall of the connector body 100 abuts against the second side wall 212, so that the connector body 100 and the main board 200 are electrically connected. The first abutment surface 101 may be a plane and have a mirror effect, and may form an attractive force when being in contact with the electrical contact site 220; or, the first abutment surface 101 may also be a convex arc surface, and an interference abutment may be formed when the first abutment surface 101 is in contact with the electrical contact site 220, so as to enhance reliability of connection between the first conductive terminal 110 and the electrical contact site 220, and ensure an effect of electrical connection between the connector body 100 and the main board 200. The connector module provided in the example may realize a force contact between the first conductive terminal 110 and the electrical contact site in the second direction Y, and electrically connect the connector body 100 and the main board 200 in this direction, which has a compact layout and a good synergistic fitting effect.

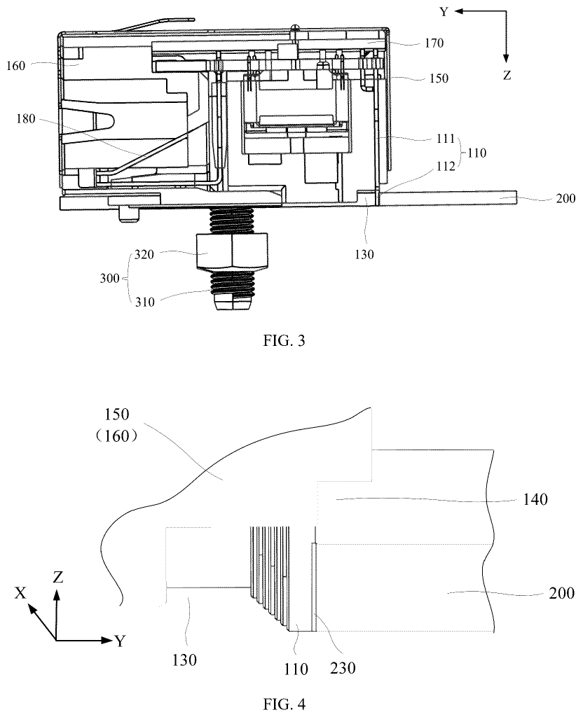

As shown in FIG. 3 to FIG. 6, in a possible example, the first conductive terminal 110 includes a fixing part 111 and a flexible part 112 connected to the fixing part 111 along the third direction Z, the connector body 100 further includes a second avoidance notch 130 disposed opposite to the second side wall 212, and the flexible part 112 is suspended in the second avoidance notch 130, so that the flexible part 112 at least has a deformation capability along the second direction Y.

In the embodiment, a specific configuration of the connector body 100 is further optimized. Specifically, the connector body 100 is configured as a combined member including at least the first conductive terminal 110, the connecting ear 120, and the second avoidance notch 130, the second avoidance notch 130 may be an internal corner structure opened at a bottom corner of the connector body 100 and passing through the connector body 100 along the first direction X, a lateral opening of the second avoidance notch 130 faces away from an opening of the first avoidance notch 210, a bottom opening of the second avoidance notch 130 faces the main board 200, and the flexible part 112 of the first conductive terminal 110 may be plugged into the second avoidance notch 130 from top to bottom. At the same time, the first conductive terminal 110 is configured as a separate body structure including at least the fixing part 111 and the flexible part 112, the fixing part 111 may be wrapped on the main body part of the connector body 100, which can not only enhance rigidity of the main body part, but also electrically connect the flexible part 112 and a control member 170 in the main body part; the flexible part 112 is connected to a lower end of the fixing part 111, and at least a part of the flexible part 112 extends out of the main body part and is exposed in the second avoidance notch 130. Thus, the flexible part 112 may at least have the deformation capability in the second direction Y when being subjected to a force in the second direction Y, to relieve an abutment stress when the flexible part 112 is in contact with the electrical contact site 220, to prevent the flexible part 112 from being broken and the electrical contact site 220 from being crushed, which may not only improve mechanical protection of the flexible part 112 and the electrical contact site 220, but also enhance sensitivity and reliability of contact between the first conductive terminal 110 and the electrical contact site 220, and shorten a response time of the connector module. The connector module provided in the example may provide an abutment buffering force for the first conductive terminal 110 and the electrical contact site 220 at least in the second direction Y, allows the first conductive terminal 110 to deform in the second direction Y, and improves an assembly yield.

As shown in FIG. 1, and FIG. 3 to FIG. 6, in a possible example, the connector body 100 further includes a third avoidance notch 140 disposed above the second side wall 212, and the third avoidance notch 140 and the second avoidance notch 130 are respectively disposed on two opposite sides of the first conductive terminal 110 along the second direction Y.

In the embodiment, the specific configuration of the connector body 100 is further optimized. Specifically, the connector body 100 is configured as a combined member including at least the first conductive terminal 110, the connecting ear 120, the second avoidance notch 130, and the third avoidance notch 140, the third avoidance notch 140 may be an internal corner structure disposed above an outer side of the second avoidance notch 130 and passing through an internal corner structure of the connector body 100 along the first direction X, a lateral opening of the third avoidance notch 140 faces away from the first avoidance notch 210, and a bottom opening of the third avoidance notch 140 is in communication with the second avoidance notch 130. A part of the fixing part 111 of the first conductive terminal 110 may be exposed through the third avoidance notch 140, so as to increase an exposed area of an outer side wall of the first conductive terminal 110, disperse an abutment force received on a side of the first abutment surface 101, reduce a breakage rate of the first conductive terminal 110, and improve the assembly yield; at the same time, a limit may be formed between a top wall of the third avoidance notch 140 and the main board 200 to prevent excessive assembly of the connector body 100 and the main board 200 in the third direction Z.

In a possible example, a projection of the first conductive terminal 110 in the third direction Z and a projection of the electrical contact site 220 in the third direction Z at least partially overlap. With such configuration, the first conductive terminal 110 and the electrical contact site 220 may be in interference abutment in the second direction Y, so as to ensure an electrical contact yield and sensitivity of the first conductive terminal 110 and the electrical contact site 220, shorten the response time of the connector module, improve a response rate, and improve a current conduction performance or a signal transmission performance of the connector module.

As shown in FIG. 4 and FIG. 5, in a possible example, the second side wall 212 is provided with at least two limiting protrusions 230 disposed at intervals in the second direction Y, adjacent two of the limiting protrusions 230 enclose a limiting groove extending along the third direction Z, and the first conductive terminal 110 is plugged in the limiting groove.

In the embodiment, a structure of an abutment point between the first conductive terminal 110 and the electrical contact site 220 is further optimized. Specifically, at least two limiting protrusions 230 are disposed on the second side wall 212 of the main board 200, the limiting protrusion 230 passes through the main board 200 along the third direction Z, and the at least two limiting protrusions 230 are distributed at intervals along the first direction X to enclose the limiting groove extending along the third direction Z. The electrical contact site 220 is disposed in the bottom of the limiting groove. When the first conductive terminal 110 is plugged in the limiting groove, the first abutment surface 101 of the first conductive terminal 110 abuts on the electrical contact site 220, and two other side walls thereof are respectively limited by inner walls of the two adjacent limiting protrusions 230, which can not only realize assembly guidance and limit of the first conductive terminal 110 through the limiting groove, improving assembly precision and assembly speed; but also can prevent the first conductive terminal 110 from moving in the second direction Y, improving assembly stability and reliability of the connector module.

In addition, the limiting protrusion 230 may be a conductive metal, and is electrically connected with the electrical contact site 220. Thus, an electrical contact area between the first conductive terminal 110 and the main board 200 may be increased through an inner wall surface of the limiting protrusions 230, improving reliability and sensitivity of the electrical contact, shorten the response time, and improve an overall performance of the connector module.

In an example, N first conductive terminals 110 are provided and are distributed at intervals along the first direction X. N electrical contact sites 220 are provided and are distributed at intervals along the first direction X. One of the electrical contact sites 220 corresponds to at least one conductive terminal. At this time, (N+1) limiting protrusions 230 are provided and are distributed at intervals along the first direction X to enclose N limiting grooves, and one limiting groove is provided with one electrical contact site 220. Thus, sensitivity of electrical contact between the connector body 100 and the main board 200 may be improved at least in quantity, the response rate may be improved, and the performance of the connector module may be improved.

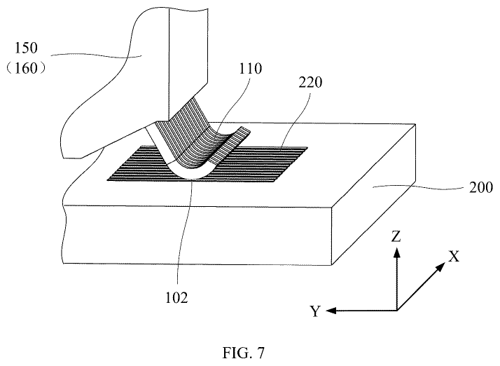

As shown in FIG. 7, in a possible example, the electrical contact site 220 is disposed on a side of the main board 200 facing the connector body 100, the first conductive terminal 110 has a second abutment surface 102 exposed from the connector body 100 and facing the electrical contact site 220, and the second abutment surface 102 abuts against and is electrically connected with the electrical contact site 220 in the third direction Z.

This embodiment provides a manner of electrical connection between the first conductive terminal 110 and the electrical contact site 220 in the third direction Z, and at this time, the first conductive terminal 110 may be a bent hook elastic piece structure. The electrical contact site 220 is disposed on a top surface of the main board 200, the second abutment surface 102 at a lowest point of the hook part of the first conductive terminal 110 is disposed facing the electrical contact site 220, and may abut tightly against the top of the electrical contact site 220 when the connector body 100 is plugged in the first avoidance notch 210. The second abutment surface 102 may be a convex arc surface, and interference abutment may be formed when the second abutment surface 102 is in contact with the electrical contact site 220; or, the second abutment surface 102 may be a smooth plane and have a mirror effect, and may form an attractive force when being in contact with the electrical contact site 220, so as to enhance reliability of connection between the first conductive terminal 110 and the electrical contact site 220, and ensure an effect of electrical connection between the connector body 100 and the main board 200. The connector module provided in the example may realize a force contact between the first conductive terminal 110 and the electrical contact site in the third direction Z, and electrically connect the connector body 100 and the main board 200 in the direction, which has a compact layout and a good synergistic fitting effect.

In a possible example, a projection of the first conductive terminal 110 in the second direction Y and a projection of the electrical contact site 220 in the second direction Y at least partially overlap. With such configuration, the first conductive terminal 110 and the electrical contact site 220 may be in interference abutment in the third direction Z, so as to ensure the electrical contact yield and sensitivity of the first conductive terminal 110 and the electrical contact site 220, shorten the response time of the connector module, improve the response rate, and improve the current conduction performance or the signal transmission performance of the connector module.

As shown in FIG. 1 to FIG. 3, in a possible example, the connector body 100 further includes a first shell 150 and a second shell 160, the first shell 150 is sleeved outside the second shell 160, the connecting ear 120 is disposed on a side of the first shell 150 facing the main board 200, one end of the first conductive terminal 110 is disposed in the second shell 160, and the other end thereof is exposed from and abuts against the electrical contact site 220.

In the embodiment, the specific configuration of the connector body 100 is further optimized. Specifically, the connector body 100 is configured as a combined member including at least the first conductive terminal 110, the connecting ear 120, the first shell 150, and the second shell 160, the first shell 150 may be a near-rectangular box-shaped structure and have a housing chamber, and the connecting ear 120 disposed on an outer wall of the first shell 150 is configured to fit the locking assembly 300 to detachably connect the connector body 100 to the main board 200. The second shell 160 may be a near-rectangular box-shaped structure, a size of the second shell 160 is smaller than a size of the first shell 150, and the second shell 160 may be housed in the housing chamber of the first shell 150 by means of locking or press-fitting. The fixing part 111 of the first conductive terminal 110 is wrapped in the second shell 160, and the flexible part 112 of the first conductive terminal 110 passes through the second shell 160 and the first shell 150 in sequence and extends out to abut against and be electrically connected with the electrical contact site 220. The connector body 100 provided in the example has a double-layer shell structure, a better overall hardness, good drop resistance and good impact resistance, and stronger stability.

As shown in FIG. 1, in a possible example, the first shell 150 has a first hollowed-out area 151 and a second hollowed-out area 152 that are adjacently disposed, the first hollowed-out area 151 is disposed facing the main board 200, the second hollowed-out area 152 is disposed on a side of the first shell 150 away from the first conductive terminal 110, the second shell 160 has a third hollowed-out area 161, the third hollowed-out area 161 is in communication with the second hollowed-out area 152 to form a plugging port, and the second shell 160 passes through the first hollowed-out area 151 and is housed in the first avoidance notch 210.

In the embodiment, a specific configuration of the first shell 150 and the second shell 160 and a synergistic assembly manner therebetween are optimized. Specifically, the first hollowed-out area 151 is disposed on a bottom surface of the first shell 150 to provide avoidance for a bottom of the second shell 160; the second hollowed-out area 152 is disposed on a side surface of the first shell 150 to provide avoidance for a side of the second shell 160; and at the same time, the third hollowed-out area 161 is disposed on a side surface of the second shell 160 to be in communication with the second hollowed-out area 152, and form the plugging port for an external active device such as a power cord interface to be inserted into, and the plugging port and the first conductive terminal 110 are distributed at intervals in the second direction Y. The connector body 100 provided in the example has a high synergistic fitting degree and a strong structural stability.

As shown in FIG. 3, in a possible example, the connector body 100 further includes a control member 170 and a second conductive terminal 180, the control member 170 is disposed in the second shell 160, the second conductive terminal 180 is electrically connected to the first conductive terminal 110 through the control member 170, and the second conductive terminal 180, the control member 170, and the first conductive terminal 110 are disposed in sequence along the second direction Y.

In the embodiment, the specific configuration of the connector body 100 is further optimized. Specifically, the connector body 100 is configured as a combined structural member including at least the first conductive terminal 110, the connecting ear 120, the first shell 150, the second shell 160, the control member 170, and the second conductive terminal 180. The control member 170 may be a circuit board or a chip, and may adhere to a bracket inside the second shell 160 by glue; the second conductive terminal 180 may be an electrical connection piece, one end of which is electrically connected to the control member 170, and the other end of which is exposed to the plugging port to be electrically connected with an external active device. Compared with a processing requirement that an electrical connection terminal in a conventional connector needs to be integrally formed and an assembly requirement between the integrally formed electrical connection terminal and the second shell 160, the connector body 100 provided in the example has a power/signal conduction path therein disposed in segments, so that the power/signal conduction path may reach a side of the first conductive terminal 110 from a side of the second conductive terminal 180 via the control member 170, and finally transmits to the main board 200 via the first conductive terminal 110 and the electrical contact site 220, which may effectively reduce a production difficulty and a subsequent assembly difficulty of the connector body 100, reduce production costs, and improve assembly efficiency.

As shown in FIG. 1 and FIG. 3, in a possible example, the locking assembly 300 includes a fastener 310 and a locking member 320, the fastener 310 passes through the connecting ear 120 and the main board 200 in sequence, and the locking member 320 is threadedly connected to a side of the fastener 310 close to the main board 200. With such configuration, the fastener 310 may pass through the via hole disposed on the connecting ear 120 and the connecting hole disposed at a corresponding position on the main board 200 in sequence, then the locking member 320 is sleeved on the side of the fastener 310 close to the main board 200, and the locking member 320 is screwed until abutting against the main board 200 to lock the connector body 100 and the main board 200 in the third direction Z, improving structural stability and reliability of the connector module.

In addition, an embodiment of the present disclosure further provides an electronic device, including the connector module as described in any of the above. A specific structure of the connector module refers to the above embodiments. Since the electronic device adopts all technical solutions of all the above embodiments, the electronic device at least has all beneficial effects brought by the technical solutions of the above embodiments, which will not be repeated one by one herein.

In the embodiment, the electronic device may include a power cord and a product such as a mobile phone, a computer, an iPad, a reader, or a smart watch (a mobile phone is taken as an example for description hereinafter). The connector module is assembled in the product. One end of the power cord may be plugged to a battery power source or a mains supply, and the other end is plugged into the plugging port of the connector body 100; the main board 200 of the connector module is assembled at a designated position of the mobile phone and is electrically connected with a main control board of the mobile phone. Thus, a current in the power battery or the mains supply may be transmitted to the mobile phone through the power cord, the second conductive terminal 180, the control member 170, the first conductive terminal 110, the electrical contact site 220, the main board 200, and the mobile phone main control board in turn, to realize charging of the mobile phone. Alternatively, the electronic device may include a data cable and a product such as a mobile phone, and the connector module is assembled in the product. One end of the data cable may be plugged to a terminal computer, and the other end is plugged into the plugging port of the connector body 100; the main board 200 of the connector module is assembled at the designated position of the mobile phone and is electrically connected with the main control board of the mobile phone. Thus, information such as picture information or text information in the mobile phone may be transmitted to a terminal through the mobile phone main control board, the main board 200, the electrical contact site 220, the first conductive terminal 110, the control member 170, the second conductive terminal 180, the data cable, and the computer in turn, to realize information transmission on the mobile phone.

In addition, in the electronic device of the example, the connector body 100 and the main board 200 are assembled into an overall structure to a designated position of the device, which may effectively reduce an assembly error, and improve assembly precision and the assembly yield. Compared with an assembly method of an electronic device in which first the main board 200 is assembled, then the connector body 100 is assembled, and finally the connector body 100 and the main board 200 are assembled, the assembly method provided in the example simplifies an assembly process of the electronic device, improves assembly efficiency, and may effectively avoid a situation of the assembly error and an incorrect assembly position between the connector body 100 and the main board 200, improve an overall structural stability and reliability, and improve an overall performance of the electronic device.

It should be understood that the terms used herein are only for the purpose of describing specific exemplary embodiments and are not intended to be limiting. Unless the context clearly indicates otherwise, the singular forms “a”, “an” and “the” as used herein can also mean including plural forms. The terms “include”, “contain”, “comprise” and “have” are inclusive and thus indicate the presence of features, steps, operations, elements and/or components described, but do not exclude the presence or addition of one or more other features, steps, operations, elements, components, and/or combinations thereof. The method steps, procedures, and operations described herein are not interpreted as necessarily requiring them to be executed in the specific order described, unless the execution order is explicitly indicated. It should also be understood that additional or alternative steps may be used.

Although a plurality of elements, components, regions, layers and/or sections can be described herein with the terms first, second, third, and the like, they should not be limited by these terms. These terms may be only used to distinguish one element, component, region, layer or section from another ones. Terms such as “first” and “second” and other numerical terms do not imply sequence or order when used herein unless clearly indicated in the context. Accordingly, the first element, component, region, layer or section discussed below may be referred to as a second element, component, region, layer or section without departing from teachings of the exemplary embodiments.

The foregoing description is only the description of embodiments of the disclosure to enable a person skilled in the art to understand or implement the disclosure. Various modifications to these embodiments will be apparent to a person skilled in the art, and general principles defined herein may be implemented in other embodiments without departing from the spirit or scope of the disclosure. Thus, the disclosure is not limited to the embodiments shown herein, but conforms to the widest scope consistent with the principles and novel characteristics applied herein.

What is claimed is:

1. A connector module, comprising:
a connector body comprising a first conductive terminal and a connecting ear, wherein the connecting ear extends outward along a first direction of the connector body, and the first conductive terminal and the connecting ear are disposed at intervals in a second direction of the connector body;
a main board provided with a first avoidance notch and an electrical contact site, wherein the first avoidance notch passes through the main board along a third direction of the connector body, the electrical contact site is disposed corresponding to the first conductive terminal, at least part of the connector body is plugged in the first avoidance notch, and the first conductive terminal abuts against and is electrically connected with the electrical contact site; and
a locking assembly locking the connector body and the main board through the connecting ear in the third direction.

2. The connector module of claim 1, wherein the first avoidance notch comprises a first side wall, a second side wall, and a third side wall that are disposed in sequence, the third side wall and the first side wall are disposed opposite and distributed at intervals in the first direction, the electrical contact site is disposed on the second side wall, the first conductive terminal has a first abutment surface exposed from the connector body and facing the second side wall, and the first abutment surface abuts against and is electrically connected with the electrical contact site in the second direction.

3. The connector module of claim 2, wherein the first conductive terminal comprises a fixing part and a flexible part connected to the fixing part along the third direction, the connector body further comprises a second avoidance notch disposed opposite to the second side wall, and the flexible part is suspended in the second avoidance notch, so that the flexible part at least has a deformation capability along the second direction.

4. The connector module of claim 3, wherein the connector body further comprises a third avoidance notch disposed above the second side wall, and the third avoidance notch and the second avoidance notch are respectively disposed on two opposite sides of the first conductive terminal along the second direction.

5. The connector module of claim 2, wherein a projection of the first conductive terminal in the third direction and a projection of the electrical contact site in the third direction at least partially overlap.

6. The connector module of claim 2, wherein the second side wall is provided with at least two limiting protrusions disposed at intervals in the second direction, adjacent two of the limiting protrusions enclose a limiting groove extending along the third direction, and the first conductive terminal is plugged in the limiting groove.

7. The connector module of claim 1, wherein the electrical contact site is disposed on a side of the main board facing the connector bod, the first conductive terminal has a second abutment surface exposed from the connector body and facing the electrical contact site, and the second abutment surface abuts against and is electrically connected with the electrical contact site in the third direction.

8. The connector module of claim 7, wherein a projection of the first conductive terminal in the second direction and a projection of the electrical contact site in the second direction at least partially overlap.

9. The connector module of claim 1, wherein the connector body further comprises a first shell and a second shell, the first shell is sleeved outside the second shell, the connecting ear is disposed on a side of the first shell facing the main board, one end of the first conductive terminal is disposed in the second shell, and the other end of the first conductive terminal is exposed from and abuts against the electrical contact site.

10. The connector module of claim 9, wherein the first shell has a first hollowed-out area and a second hollowed-out area that are adjacently disposed, the first hollowed-out area is disposed facing the main board, the second hollowed-out area is disposed on a side of the first shell away from the first conductive terminal, the second shell has a third hollowed-out area, the third hollowed-out area is in communication with the second hollowed-out area to form a plugging port, and the second shell passes through the first hollowed-out area and is housed in the first avoidance notch.

11. The connector module of claim 9, wherein the connector body further comprises a control member and a second conductive terminal, the control member is disposed in the second shell, the second conductive terminal is electrically connected to the first conductive terminal through the control member, and the second conductive terminal, the control member, and the first conductive terminal are disposed in sequence along the second direction.

12. The connector module of claim 1, wherein the locking assembly comprises a fastener and a locking member, the fastener passes through the connecting ear and the main board in sequence, and the locking member is threadedly connected to a side of the fastener close to the main board.

13. An electronic device comprising the connector module of claim 1.

14. The electronic device of claim 13, wherein the first avoidance notch comprises a first side wall, a second side wall, and a third side wall that are disposed in sequence, the third side wall and the first side wall are disposed opposite and distributed at intervals in the first direction, the electrical contact site is disposed on the second side wall, the first conductive terminal has a first abutment surface exposed from the connector body and facing the second side wall, and the first abutment surface abuts against and is electrically connected with the electrical contact site in the second direction.

15. The electronic device of claim 14, wherein the first conductive terminal comprises a fixing part and a flexible part connected to the fixing part along the third direction, the connector body further comprises a second avoidance notch disposed opposite to the second side wall, and the flexible part is suspended in the second avoidance notch, so that the flexible part at least has a deformation capability along the second direction.

16. The electronic device of claim 15, wherein the connector body further comprises a third avoidance notch disposed above the second side wall, and the third avoidance notch and the second avoidance notch are respectively disposed on two opposite sides of the first conductive terminal along the second direction.

17. The electronic device of claim 14, wherein the second side wall is provided with at least two limiting protrusions disposed at intervals in the second direction, adjacent two of the limiting protrusions enclose a limiting groove extending along the third direction, and the first conductive terminal is plugged in the limiting groove.

18. The electronic device of claim 13, wherein the electrical contact site is disposed on a side of the main board facing the connector bod, the first conductive terminal has a second abutment surface exposed from the connector body and facing the electrical contact site, and the second abutment surface abuts against and is electrically connected with the electrical contact site in the third direction.

19. The electronic device of claim 13, further comprising a power cord and a product, wherein the connector module is assembled in the product, one end of the power cord is plugged to a battery power source or a mains supply, and the other end of the power cord is plugged into the connector module.

20. The electronic device of claim 13, further comprising a data cable and a product, wherein the connector module is assembled in the product, one end of the data cable is plugged to a terminal computer, and the other end of the data cable is plugged into the connector module.
